(19) United States
(12) Patent Application Publication
(10) Pub. No.: US 2005/0047368 A1
(43) Pub. Date: Mar. 3, 2005

(54) Handover during packet sessions in wireless communications networks and methods

(76) Inventors: Michael D. Kotzin, Buffalo Grove, IL (US); Stephen L. Spear, Skokie, IL (US)

Correspondence Address: MOTOROLA INC, 600 NORTH US HIGHWAY 45, ROOM AS437, LIBERTYVILLE, IL, 60048-5343, US

(21) Appl. No.: 10/647,410

(22) Filed: Aug. 25, 2003

(51) Int. Cl. H04Q 7/00

(52) U.S. Cl. 370/331

(57) ABSTRACT

A method in a wireless communications network connected to a packet network including receiving (410) at a packet server handover information, e.g., neighbor measurements, from a wireless communications device, negotiating (420) with the radio communications network, e.g., with a base station controller, for a radio resource transfer for a mobile wireless communications device, and sending (440), from the packet server, radio resource information to the mobile wireless communications device.

### FIELD OF THE DISCLOSURE

The present disclosure relates generally to wireless communications, and more particularly to wireless communications device handover during packet data sessions in communications networks, for example, while communicating packet data in General Packet Radio Service (GPRS) enabled cellular communications networks, and methods.

### BACKGROUND OF THE DISCLOSURE

In the GPRS protocol, as a mobile subscriber terminal or device moves about during a data session, the subscriber device re-selects serving cells based on reselection measurements made at the subscriber device. Unlike network-controlled handover where the radio resource assignment is prepared by the network before handover, reselection requires that the subscriber device request radio resources, timeslot assignment, etc., after reselection to the new serving cell. This procedure requires time during which the transmission of packet data is interrupted. The discontinuity in data transmission may be particularly prolonged when the mobile terminal travels from one Serving GPRS Support Node (SGSN) to another SGSN, for example, when roaming in different networks and when traveling in large networks having multiple SGSNs. Some packet data, for example, some File Transport Protocol (FTP) session data packets, may be buffered or re-transmitted if delayed or lost, but other data, for example, real-time packet data, generally cannot be delayed or recovered if lost. It is desirable generally to reduce the time required for handover during packet data sessions.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates a wireless communications device in a packet session in a wireless communications network.

FIG. 2 is an exemplary mobile terminal process diagram.

FIG. 3 illustrates a wireless communications device transmitting information to a packet server during a packet session.

FIG. 4 is an exemplary packet server process diagram.

FIG. 5 illustrates a packet server negotiating with a network while a wireless communications device is in a packet session.

FIG. 6 illustrates a packet server receiving radio resource transfer information from communications network.

FIG. 7 illustrates a packet server sending radio resource transfer information to a wireless communications device.

FIG. 8 illustrates a wireless communications device in a packet session in a wireless communications network.

### DETAILED DESCRIPTION

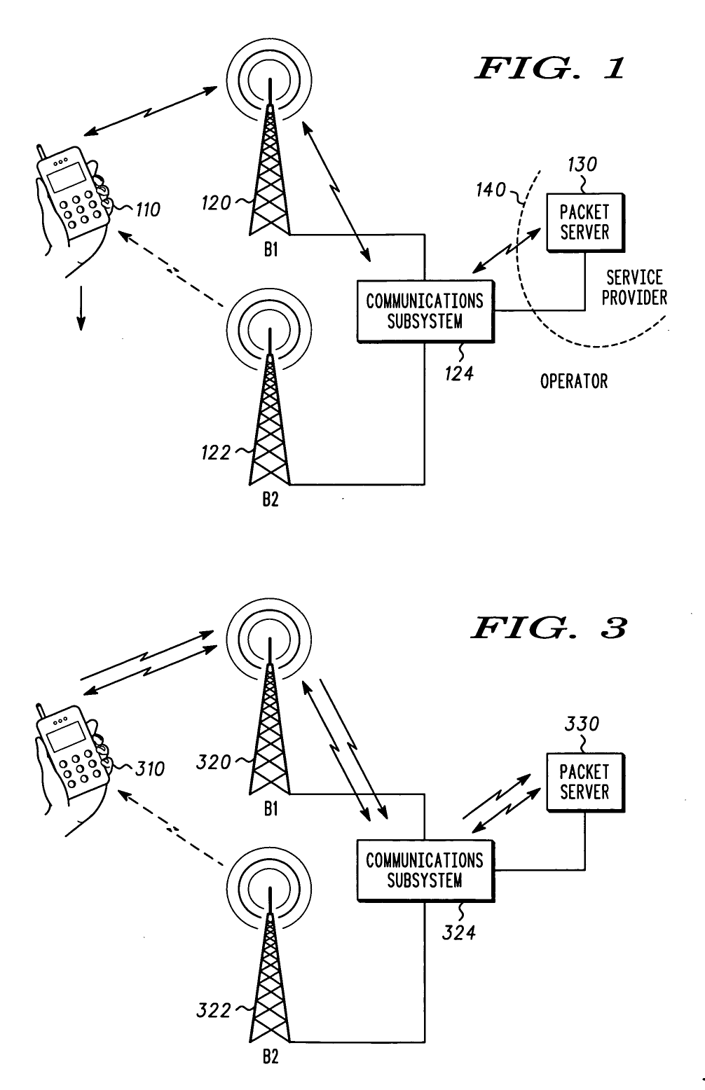

In the FIG. 1, a wireless communications device 110, for example, a mobile cellular subscriber terminal or other wireless communications enabled device, communicates in a wireless communications network including a packet data network. The exemplary communications network includes more specifically a first base station (B1) transceiver 120 and a second base station transceiver (B2) 122 in communication with a radio communications subsystem 124, including one or more base station controllers and other network infrastructure known are known generally by those of ordinary skill in the art but not illustrated in FIG. 1.

The exemplary network may be a 2nd Generation (2G) Global System for Mobile Communications (GSM) radio access network, or a 3rd Generation (3G) Universal Mobile Telephone System (UMTS) data interchange network, or a combination of 2G and 3G networks, or some other communications network, for example a 2.5G network.

In FIG. 1, the exemplary communications network provides a packet service via a packet network, for example, a General Packet Radio Service (GPRS) packet network or GPRS/Enhanced Data for Global Evolution (EDGE), or some other packet network that is coupled to or a part of the communications network. In FIG. 1, the packet network includes a packet server 130 coupled to the communications network, which typically communicates with packet data networks via one or more Serving GPRS Support Nodes (SGSN) and a Gateway GPRS Support Node (GGSN) of the radio communications subsystem 124 illustrated in FIG. 1. The SGSN and GGSN are known generally by those of ordinary skill in the art and not illustrated in FIG. 1. In FIG. 1, the interface between the exemplary wireless communications network and the packet network is demarked by schematic interface 140.

In one embodiment, a wireless communications device participating in a packet session while connected to the wireless network communication network via at least one base station, or multiple nodes, makes measurements on signals from neighboring cells as the mobile terminal moves about. In FIG. 1, for example, wireless communications device 110 is connected to the communications network by serving base station transceiver 120 receives and measures signals from base station 122 while in a packet session.

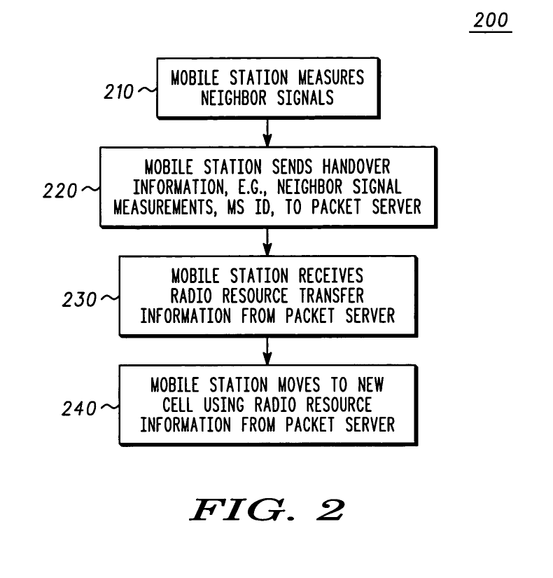

In the exemplary wireless communications device process 200 of FIG. 2, at block 210, the wireless communications device receives and measures signals from neighboring base station transceivers. The measurements made by the mobile terminal are typically those required by the particular communications protocol for determining when handover to another serving cell is necessary or permitted and for determining to which cell the wireless communications device will move. The measurement of neighboring signals generally occurs while the wireless communications device is in the packet session.

In one embodiment, the wireless communications device sends handover information to a packet server while in the packet session, as illustrated in FIG. 2 at block 220. In FIG. 3, for example, the wireless communications device 310 communicates handover information to the packet server 330 via base station 320 and radio communications subsystem 324. The handover information is based generally on the neighbor signal measurements made by the wireless communications device, for example, measurements made on neighbor cell 322, among other cells. In one embodiment, the handover information sent by the wireless communications device to the packet server includes information identifying one or more potential future serving cells, or handover targets, to which the subscriber terminal may handover.

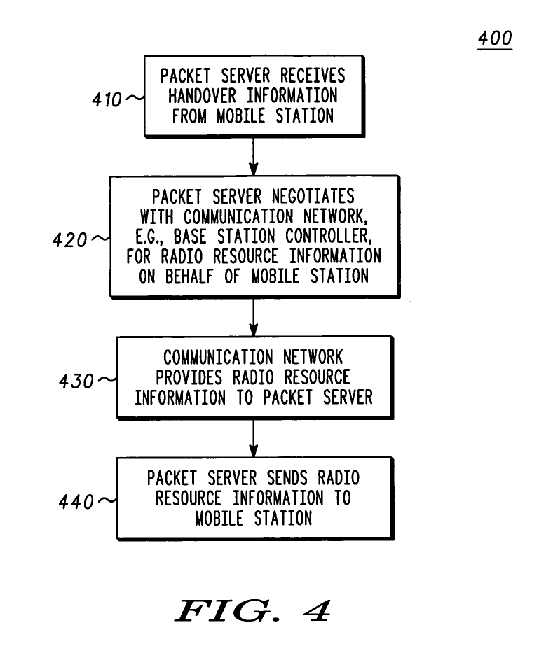

In the exemplary packet server process 400 illustrated in FIG. 4, at block 410, the packet server receives handover information from the subscriber terminal. As noted above, the handover information may be based on or include neighbor cell measurements and/or it may include potential handoff target information.

The handover information may in some embodiments include location information, for example, satellite and/or terrestrial positioning system based location information, among other information about the mobile communications device. In some embodiments, the packet server derives timing advance information from the location information. The subscriber terminal may use the timing advance information to reduce the access time on the target channel. The derivation of the timing advance information may be performed at the packet server, or alternatively in the radio sub-system or in the subscriber device.

In some embodiments, reselection measurement information also includes neighbor timing information, which may be used by the packet or the radio communication subsystem to derive timing advance information for use by the subscriber terminal to reduce the access time on the target channel.

In one embodiment, the subscriber terminal makes the handover target decision, and one or more potential handover targets or serving cells are identified by the subscriber terminal, for example, based on reselection measurements. The handover target information may be transmitted to the packet server in the form of a handover request, whereupon the packet server negotiates with the communications network, for example with a network base station controller, on behalf of the mobile wireless communications device as discussed above. In other embodiments, the target selection resides with the radio communications network or alternatively with the packet server. As noted the handover target decision may be based upon neighbor signal measurements or other information provided by the wireless communications device to the communications network and/or to the packet server. The particular communication protocol employed and the location where handover decision is made may generally have some bearing on what information is provided by the wireless communications device to the network or to the packet server.

Upon determining that handover will occur, the packet server negotiates with the communications network for a radio resource transfer for the mobile communications device, as illustrated in FIG. 4 at block 420.

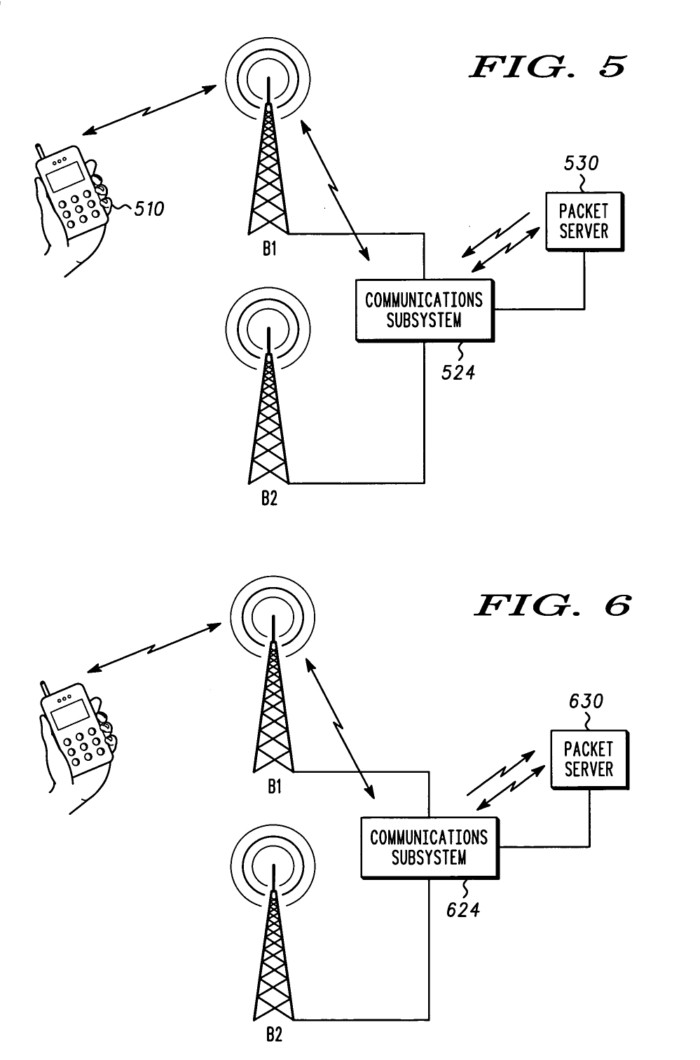

In FIG. 5, for example, the packet server 530 negotiates with the radio communications subsystem 524 for radio resources for the wireless communications device. The radio resource assignment negotiation occurs before the wireless communications device 510 hands off to the new serving cell and while the mobile communications device is in the packet session.

In one embodiment, the radio resource transfer negotiation includes reselection functionality normally performed by the wireless communications device during a typical reselection performed by the mobile device. The subject of the negotiation includes generally any required negotiation that would interrupt the communications of data during the data session if performed by the wireless communications device. Specific, though non-exclusive and non-limiting, examples of matters negotiated include: the communication of mobile device identification to the network and future serving cell; negotiations for frequency and slot assignment; time-to-transfer; power information, etc.

After completion of the negotiation between the packet server and the communications network, the communications network provides radio resource transfer information to the packet server as illustrated at block 430 in FIG. 4. In FIG. 6, after negotiation, the communications network, e.g., the radio communications subsystem 624 provides radio resource transfer information to the packet server 630.

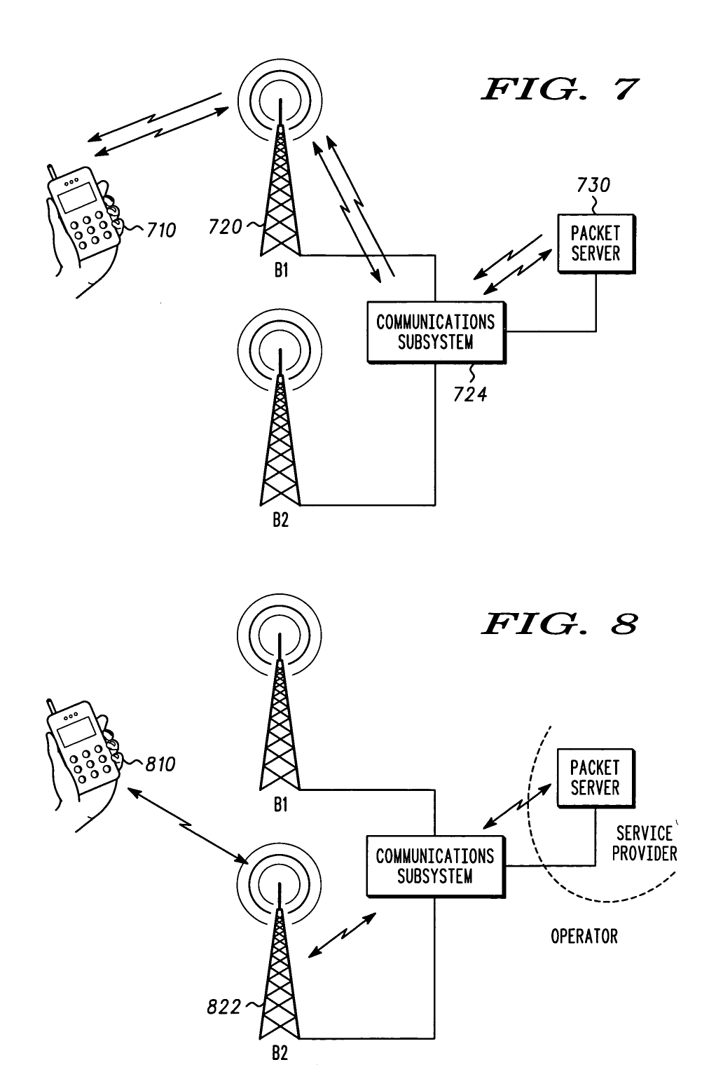

In FIG. 4, at block 440, the packet server sends or communicates radio resource transfer information to the wireless communications device after negotiating with the network as discussed above. In FIG. 7, for example, the packet server 730 sends the radio resource transfer information to the wireless communications device 710 via the radio communications subsystem 724 and the base station transceiver 720. In FIG. 2, at block 230, the wireless communication device receives the radio resource transfer information from the packet server.

In FIG. 2, at block 240, the wireless communications device hands-over to a new serving base station transceiver the using the radio resource information received from the packet server. In FIG. 8, the wireless communications device 810 hands-over to a new serving cell 822. Use of the radio resource information provided to the wireless communications device by the packet server enables reduction in the interruption of data communication during the packet session while handing over to the new cell. For example, the subscriber terminal may receive from the packet server and use timing advance, frequency and time slot assignment, time to transfer and other information from the packet server to reduce the time to handover to a new serving cell.

In one embodiment, if the packet server is unable to negotiate radio resources for the wireless communications device, the wireless communications device may re-select autonomously as is known in the art. For example, if the packet server does not send radio resource information to the wireless communication device within a specified time period after the wireless communications device sends handover information to the packet server, the wireless communications device may reselect autonomously.

In some applications, negotiation of the radio resource transfer by the packet server may substantially reduce data lost during handover, for example, when handing over between different SGSNs in different communications networks or in large communications networks, thus providing substantially seamless handovers.

It has been proposed to deploy voice direct-connect services including push-to-talk (PTT) services in mobile subscriber devices using the Voice over Internet Protocol (VoIP) on the General Packet Radio Service (GPRS) in Global System for Mobile (GSM) communications networks. Such a proposal requires the communication of voice over a packet data connection during a data session, instead of a circuit connection over which voice is usually communicated. The negotiation of radio resources by a PTT packet server may help reduce the loss of voice data during handover in communications architectures where voice is communicated over a packet connection.

While the present disclosure and what are considered presently to be the best modes of the inventions have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

1. A method in a mobile communications device, the method comprising:
participating in a packet session;
sending handover information to a packet server while in the packet session;
receiving radio resource information from the packet server in response to sending the handover information to the packet server.

2. The method of claim 1,
handing over to a new cell using the radio resource information received from the packet server.

3. The method of claim 2,
the radio resource information received from the packet server includes radio resource assignment information,
handing over to the new cell without requiring the mobile communications device to request a radio resource assignment from the new cell.

4. The method of claim 1, receiving radio resource information from the packet server in response to sending handover information to the packet server includes receiving at least one of frequency, slot, time-to-transfer and power information from the packet server.

5. The method of claim 1,
making neighbor measurements during the packet session;
sending the handover information to the packet server include sending information based on the neighbor measurements.

6. The method of claim 1, sending the identification of at least one handover target to the packet server.

7. The method of claim 1,
participating in the packet session includes communicating voice data in the packet session;
sending the handover information to the packet server while communicating voice data in the packet session.

8. The method of claim 7,
identifying at least one potential handover target to the packet server,
receiving radio resource information from the packet server for at least one of the handover targets identified.

9. The method of claim 1,
reducing interruption of the packet session during handover by using the radio resource information received from the packet server to facilitate handover to a new cell.

10. A method in a packet server connected to a communications network, the method comprising:
negotiating with a radio communications network for a radio resource transfer for a mobile wireless communications device,
sending, from the packet server, radio resource information to the mobile wireless communications device.

11. The method of claim 10,
receiving, at the packet server, handover information from a mobile wireless communications device,
sending the radio resource information to the mobile wireless communications device after negotiating in response to receiving the handover information.

12. The method of claim 11, negotiating with the radio communications network for a radio resource transfer for the mobile wireless communications device based on the handover information received from the mobile wireless communications device.

13. The method of claim 10,
receiving handover information from the mobile wireless communications device includes receiving at least one potential handover target identified by the mobile wireless communications device,
sending radio resource information to the mobile wireless communications device for at least one of the handover targets identified by the mobile wireless communications device.

14. The method of claim 10, sending radio resource information from the packet data server includes sending at least one of frequency, slot, time-to-transfer and power information to the mobile wireless communications device.

15. A method in a mobile communications device in a packet session, the method comprising:
receiving radio resource information from a packet server;
handing over to a new cell during the packet session;
reducing interruption of data communication during the packet session while handing over to the new cell using the radio resource information received from the packet server.

16. The method of claim 15, participating in voice communications in the packet session.

17. The method of claim 15,
receiving radio resource information from the packet server includes receiving handover timing information,
reducing interruption of the data communications during the packet session during hand over by making a timed transfer to the new cell using the handover timing information from the packet server.
